(19) United States
(12) Patent Application Publication
(10) Pub. No.: US 2008/0096063 A1
(43) Pub. Date: Apr. 24, 2008

(54) Fuel Cell Power Generating System for Executing Off Gas Treatment of Fuel Cells

(75) Inventors: Karuki Hamada, Kanagawa-ken (JP); Tadashi Shoji, Kanagawa-ken (JP); Masahiro Usuda, Kanagawa-ken (JP); Nobuo Sakiyama, Kanagawa-ken (JP)

Correspondence Address: FOLEY AND LARDNER LLP;SUITE 500, 3000 K STREET NW, WASHINGTON, DC, 20007, US

(73) Assignee: NISSAN MOTOR CO., LTD., Yokohama-shi, Kanagawa-ken (JP)

(21) Appl. No.: 11/572,946

(22) PCT Filed: Jul. 7, 2005
(86) PCT No.: PCT/JP05/12972

§ 371 Date: Jan. 30, 2007

(30) Foreign Application Priority Data
Jul. 30, 2004 (JP) 2004-222830

(51) Int. Cl. H01M 8/04; H01M 8/06

(52) U.S. Cl. 429/19; 429/22; 48/61

(57) ABSTRACT

An aspect of the present invention provides a fuel cell power generating system that includes a fuel cell having an anode serving as a fuel electrode and a cathode serving as an oxidant electrode a treatment unit configured to treat anode off gas that is discharged from the anode of the fuel cell, by mixing or reacting the anode off gas with air a anode-side discharge passage configured and arranged to supply anode off gas to the treatment unit, and a supply unit configured and arranged to supply air to the treatment unit, said air not being cathode off discharged from the cathode of the fuel cell.

### TECHNICAL FIELD

The present invention relates to a fuel cell power generating system. More specifically, the present invention relates to a technology for treating the anode off gas discharged from the anode of a fuel cell by means of combustion or other treatment before the off gas is released to the atmosphere.

### BACKGROUND ART

Japanese Laid-open Patent Publication No. 2004-164951 (particularly paragraphs 0016 to 0018) discloses a technology for treating the anode off gas of a fuel cell. The technology disclosed in the publication includes a treatment device that has a built-in catalytic converter and is installed inside an exhaust passage on the anode side of the fuel cell. Both the anode off gas and cathode off gas discharged from the cathode are fed into the treatment device, where the hydrogen in the anode off gas is combusted with the cathode off gas (more precisely, the oxygen remaining in the cathode off gas) in the presence of the catalyst.

### DISCLOSURE OF THE INVENTION

The treatment device disclosed is problematic in that the content of oxygen in the cathode off gas is reduced as a result of the electricity generating reaction and the humidity of the cathode off gas is increased due to the additional water produced during the generation of electricity. Consequently, when the cathode off gas is fed into the treatment device, retarded (delayed) ignition occurs during the combustion of the discharged hydrogen and the there is the risk that untreated hydrogen will be released into the air.

The following technologies are feasible methods of improving the ignitability when cathode off gas is used.

a) Preheating the catalyst

A method of preheating the catalyst is to use an electrically heated catalyst that can generate its own heat. With this method, the heat of the catalyst is absorbed by the cathode off gas during heating and the energy consumed in heating the catalyst becomes large, making this method inefficient. Additionally, since the concentration of oxygen in the cathode off gas is low, it is necessary to introduce a large quantity of cathode off gas, which further exacerbates the inefficiency of the heating.

b) Preheating the cathode off gas

A method of preheating the cathode off gas is to arrange for the cathode off gas to exchange heat with the exhaust gas discharged from a combustor. However, when the anode off gas is introduced to the combustor intermittently (the anode off gas is normally recirculated to the fuel cell), the cathode off gas cannot be heated in a consistent manner.

c) Separating moisture from the cathode off gas

A method of separating moisture from the cathode off gas is to use a steam exchange membrane and a liquid water trap. However, even if this method is used, the effects of the moisture in the cathode off gas cannot be completely eliminated.

The flow rate of the cathode off gas should actually be determined in relation to the operating conditions of the fuel cell and a flow rate determined based on the operating conditions of the fuel cell will not necessarily be optimum from the standpoint of the treatment efficiency of the anode off gas.

The object of the present invention is to improve the efficiency with which an off gas treatment device for a fuel cell treats anode off gas by improving the air supply system that supplies air to the treatment device.

An aspect of the present invention provides a fuel cell power generating system that includes a fuel cell having an anode serving as a fuel electrode and a cathode serving as an oxidant electrode a treatment unit configured to treat anode off gas that is discharged from the anode of the fuel cell, by mixing or reacting the anode off gas with air a anode-side discharge passage configured and arranged to supply anode off gas to the treatment unit, and a supply unit configured and arranged to supply air to the treatment unit, said air not being cathode off discharged from the cathode of the fuel cell.

### BRIEF DESCRIPTION OF DRAWINGS

FIG. 1 shows the constituent features of a fuel cell power generating system in accordance with a first embodiment of the present invention.

FIG. 2 is a flowchart of the hydrogen discharge control determining routine used in this embodiment.

FIG. 3 is a flowchart showing the routine executed in order to accomplish the hydrogen discharge.

FIG. 4 shows the combustor internal temperature Tb and the operation of the auxiliary catalyst 1152, the air supply valve 127, and the fuel gas discharge valve 114.

FIG. 5 shows a flowchart of a startup combustion control routine.

FIG. 6 shows the combustor internal temperature Tb and the flow rates of hydrogen and air supplied to the discharged hydrogen combustor 115 during startup combustion control.

FIG. 7 shows the constituent features of a power generating system in accordance with a second embodiment of the present invention.

FIG. 8 shows the constituent features of an off gas treatment device in accordance with a third embodiment of the present invention.

### BEST MODE FOR CARRYING OUT THE INVENTION

Various embodiments of the present invention will be described with reference to the accompanying drawings. It is to be noted that same or similar reference numerals are applied to the same or similar parts and elements throughout the drawings, and the description of the same or similar parts and elements will be omitted or simplified.

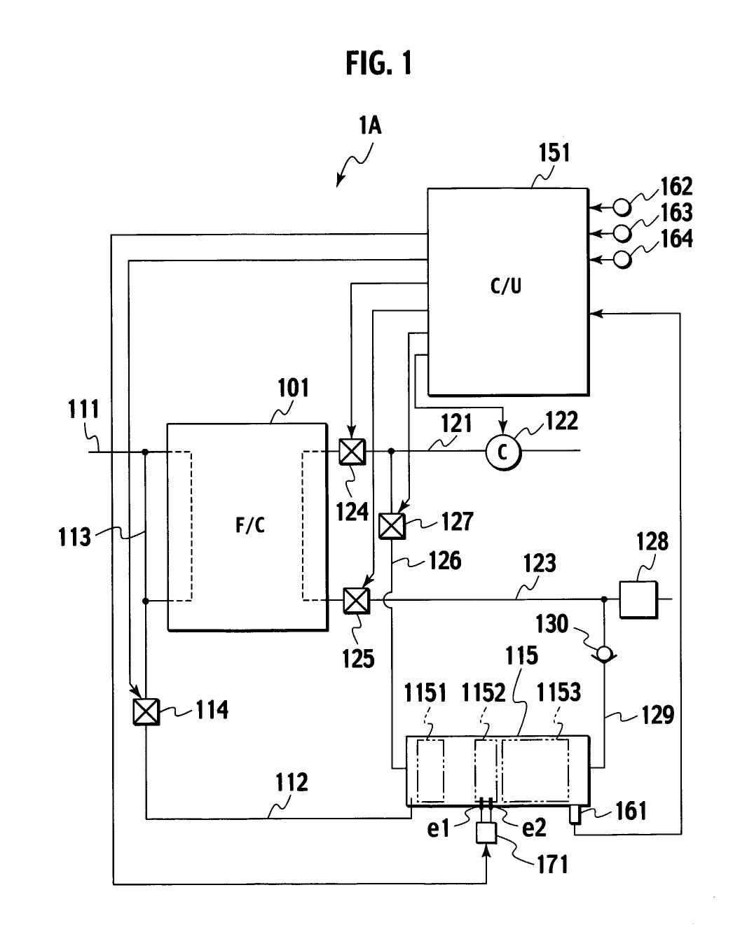

FIG. 1 shows the constituent features of a fuel cell power generating system (hereinafter called “power generating system”) 1A in accordance with a first embodiment of the present invention. The power generating system 1A is provided with an off gas treatment device in accordance with this embodiment and a fuel cell 101. The fuel cell 101 has an anode (negative electrode) serving as a fuel electrode and a cathode (positive electrode) serving as an oxidant (air) electrode and is configured to convert the chemical energy of the fuel into electrical energy. A fuel gas supply pipe 111 is connected to the anode of the fuel cell and serves as an anode-side introducing passage. The fuel gas supply pipe 111 is connected to a high-pressure hydrogen tank (not shown) and has a pressure control valve installed therein. The hydrogen stored in the high-pressure hydrogen tank lowered to a prescribed pressure before it is supplied to the anode. A fuel gas discharge pipe 112 is also connected to the anode and serves as an anode-side discharge passage. The fuel gas discharge pipe 112 and the fuel gas supply pipe 111 are connected together by a fuel gas recirculation pipe 113. The fuel gas recirculation pipe 113 is a recirculation passage serving to recirculate a prescribed ratio of the anode off gas back to the anode. A fuel gas discharge valve 114 is installed in the fuel gas discharge pipe 112 at a position downstream of where the fuel gas discharge pipe 112 connects to the fuel gas recirculation pipe 113. The fuel gas discharge valve 114 serves as a discharge control valve to control the flow rate of anode off gas flowing through the fuel gas discharge pipe 112. Thus, the fuel gas discharge valve 114 controls the ratios of anode off gas that are recirculated to the anode and introduced into an discharged hydrogen combustor 115 located downstream. The discharged hydrogen combustor 115 serves as a treatment unit and is installed in the fuel gas discharge pipe 112 at a position downstream of the fuel gas discharge valve 114.

Meanwhile, an air supply pipe 121 is connected to the cathode of the fuel cell 101 and serves as a cathode-side introducing passage. A compressor 122 (corresponding to the first air supply unit) is installed in the air supply pipe 121 and serves to compress the air supplied to the cathode. An air discharge pipe 123 is also connected to the cathode and serves as a cathode-side discharge passage. Oxidant gas supply valves 124 and 125 for controlling the flow rate of air supplied to the cathode are installed in the air supply pipe 121 and the air discharge pipe 123, respectively. The two flow rate control valves 124, 125 correspond to the second flow rate control valve. Although in this embodiment two flow rate control valves 124, 125 are provided as the second flow rate control valve, it is also acceptable to provide only one or the other of the flow rate control valves 124, 125. An air branch pipe 126 is connected to the air supply pipe 121 at a position upstream of the oxidant gas supply valve 124. The air branch pipe 126 serves as a branch passage and is connected to the discharged hydrogen combustor 115. The air supply valve 127 is installed in the air branch pipe 126. The air supply valve 127 corresponds to the first flow rate control valve and serves to control the flow rate of the air supplied to the discharged hydrogen combustor 115.

The discharged hydrogen combustor 115 treats the anode off gas introduced thereto by combusting the discharged hydrogen contained in the anode off gas. The anode off gas is discharged in order to discharge accumulated nitrogen and water from the system, but hydrogen is also contained in the anode off gas. Consequently, it is necessary to treat the discharged hydrogen. The discharged hydrogen combustor 115 includes a dilution element 1151, an auxiliary catalyst 1152, and a main catalyst 1153 arranged in order as listed from the inlet. The discharged hydrogen introduced into the discharged hydrogen combustor 115 is first mixed thoroughly with air by the dilution element 1151 and fed to the catalysts 1152, 1153 located downstream. The auxiliary catalyst 1152 is an electrically heated catalyst with self-heating and generates heat and, thereby, heat the inside of the discharge hydrogen combustor 115 when a voltage is applied to electrodes e1 and e2. Meanwhile, the main catalyst 1153 carries a precious metal such as platinum and its main function is to accelerate the combustion of the discharged hydrogen.

In this embodiment, an exhaust muffler 128 is installed in the air discharge pipe 123 to reduce the exhaust noise and lower the off gas temperature. The discharged hydrogen combustor 115 and the air discharge pipe 123 are connected together by a combustion gas discharge pipe 129 at a position upstream of the exhaust muffler 128. The combustion gas discharge pipe 129 corresponds to the connecting passage. A check valve 130 arranged to allow combustion gas to flow from the combustion gas discharge pipe 129 to the air discharge pipe 123 is installed in the combustion gas discharge pipe 129. A shut-off valve arrangement configured to merely open and close the passage or a proportional valve arrangement configured to operate according to the pressure difference across the valve can be used as the check valve 130.

A control unit 151 controls the operation of the fuel gas discharge valve 114, the oxidant gas supply valves 124, 125, and the air supply valve 127. The control unit 151 receives a detection signal indicating the operating conditions of the fuel cell 101 and a detection signal indicating the combustor internal temperature Tb (i.e., temperature inside the combustor 115) detected by a temperature sensor 161. The temperature sensor 161 detects the temperature of a combustion chamber in which the catalysts 1152, 1153 are installed as the combustor internal temperature Tb of the discharged hydrogen combustor 115. The operating conditions of the fuel cell 101 include the flow rate of hydrogen-containing fuel gas supplied to the anode, the flow rate of the oxidant gas (air in this embodiment) supplied to the cathode, and the electric current generated by the fuel cell 101. The flow rate of fuel gas to the anode is detected by a flow rate sensor 162 installed in the fuel gas supply pipe 111, the flow rate of oxidant gas is detected by a flow rate sensor 163 installed in the air supply pipe 121, and the electric current generated by the fuel cell 101 is detected by an electric current sensor 164 (measures electric current flowing to electrical load) installed in a circuit external to the fuel cell 101. The control unit 151 executes hydrogen discharge control and start-up combustion control (described later) based on the information that the control unit 151 receives from the input signals.

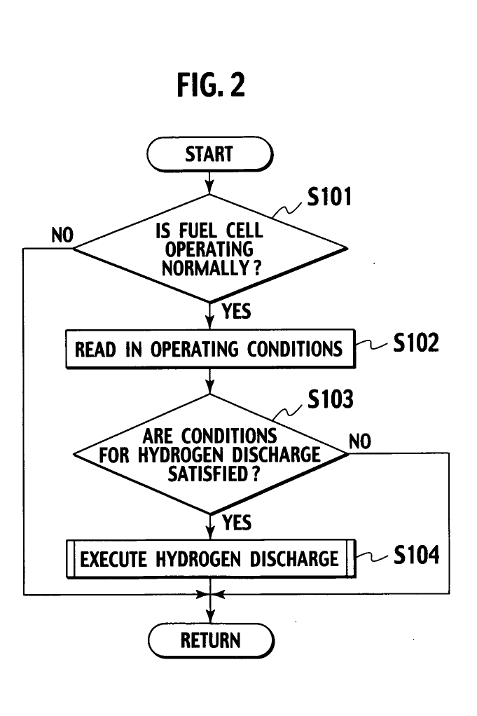

The operation of the control unit 151 will now be described with reference to flowcharts shown in the figures. FIG. 2 is a flowchart of the hydrogen discharge control determining routine used in this embodiment. It is acceptable for the hydrogen discharge control determining routine to be executed once per prescribe cycle time (e.g., once every 100 ms). In step S101 of the routine shown in FIG. 2, the control unit 151 determines if the fuel cell 101 is operating normally. If the fuel cell 101 is operating normally, the control unit 151 proceeds to step S102. If not, the control unit 151 ends the hydrogen discharge control determining routine. Thus, the control unit 151 switches between routines according to the situation.

In step S102, the control unit 151 reads in the supply flow rate of the fuel gas, the supply flow rate of the oxidant gas, the generated electric current of the fuel cell 101, etc., as parameters indicating the operating conditions of the fuel cell 101. The electrode temperatures of the anode and cathode, the supply pressures of the fuel gas and oxidant gas, and/or the voltage or power generated by the fuel cell 101 can be detected instead of or in addition to the parameters mentioned above.

In step S103, the control unit 151 determines if the conditions for hydrogen discharge are satisfied based on the operating conditions detected in the previous step. If so, the control unit 151 proceeds to step S104. If not, the control unit 151 ends the routine. The determination regarding the conditions for hydrogen discharge can be made, for example, by determining if the gas passage pressure inside the anode is equal to or above a prescribed pressure or determining if the electricity generating efficiency of the fuel cell 101 has declined to or below a prescribed efficiency.

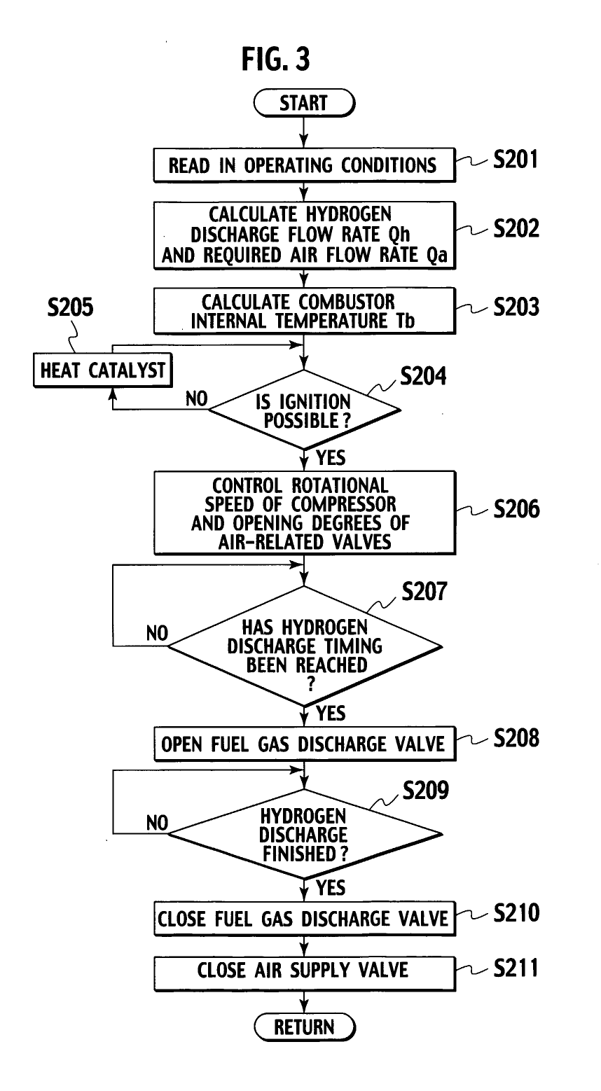

In step S104, the control unit 151 executes the hydrogen discharge. FIG. 3 is a flowchart showing the routine executed in order to accomplish the hydrogen discharge. In Figure S201, the control unit 151 reads the fuel gas supply flow rate and other operating conditions of the fuel cell 101. In step S202, the control unit 151 calculates flow rate of the hydrogen to be discharged to the outside of the system (hereinafter called “hydrogen discharge flow rate”) Qh based on the read operating conditions and calculate the required air flow rate Qa for obtaining a prescribed air-fuel ratio with respect to the calculated hydrogen discharge flow rate Qh.

In step S203, the control unit 151 detects the combustor internal temperature Tb based on the output from the temperature sensor 161. In step S204, the control unit 151 determines if the discharged hydrogen combustor 115 is in such a state that it can ignite the discharged hydrogen. The determination regarding ignitability is accomplished by determining if the combustor internal temperature Tb has reached a prescribed ignitable temperature Tpre. The prescribed ignitable temperature Tpre can be set based on the ratio of the required air flow rate Qa to the hydrogen discharge flow rate Qh (i.e., the air-fuel ratio) and the gas space velocity inside the catalyst. In this embodiment, the prescribed ignitable temperature Tpre is set based on the air-fuel ratio and the gas space velocity and is contrived to be the minimum temperature at which ignition is possible. If ignitable conditions exist, the control unit 151 proceeds to step S206. Otherwise, the control unit 151 proceeds to step S205 to heat the catalyst and returns to step S204 to determine if ignitable conditions exist. In step S205, the control unit 151 applies a voltage to the electrodes e1, e2 of the auxiliary catalyst 1152 from a power source 171; the auxiliary catalyst 1152 emits heat and heats the discharged hydrogen combustor 115.

In step S206, the control unit 151 calculates the rotational speed of the compressor 122 and the opening degree of the air supply valve 127 to be used during hydrogen discharge based on the increased required air flow rate Qa and controls the compressor 122 and the air supply valve 127 based on the newly calculated compressor rotational speed and valve opening degree. In conjunction with the control of the air supply valve 127, the control unit 151 also controls the oxidant gas supply valves 124, 125 to adjust the flow rate ratio of the air supplied to the anode and the air supplied to the discharged hydrogen combustor 115.

In step S207, the control unit 151 calculates the opening degree of the fuel gas discharge valve 114 to be used during the hydrogen discharge based on the hydrogen discharge flow rate Qh and determines if the timing for opening the fuel gas discharge valve 114 (hereinafter called “hydrogen discharge timing”) has been reached. The hydrogen discharge timing is determined in relation to the opening timing of the air supply valve 127 and the operation timing of the compressor and is set such that the discharged hydrogen and the air are supplied to the discharged hydrogen combustor 115 substantially simultaneously. If the hydrogen discharge timing has been reached, the control unit 151 proceeds to step S208. If not, the control unit 151 repeats step S207 and waits until the hydrogen discharge timing is reached. It is also possible to set the hydrogen discharge timing such that the discharged hydrogen reaches the discharged hydrogen combustor 115 ahead of the air by advancing the hydrogen discharge timing with respect to the open timing of the air supply valve 127 or to set the hydrogen discharge timing such that the discharged hydrogen reaches the discharged hydrogen combustor 115 later than the air by retarding the hydrogen discharge timing with respect to the open timing of the air supply valve 127. The hydrogen discharge timing can also be switched (changed) in accordance with the state of the discharged hydrogen combustor 115. Supplying the hydrogen ahead of the air enables reliable ignition to be obtained and supplying the air ahead of the hydrogen enables excessive combustion of the hydrogen to be avoided. The hydrogen discharge timing can be set by reverse calculating based on the pipe diameters and pipe lengths of the fuel gas discharge pipe 112 and air branch pipe 126, the discharged hydrogen flow rate Qh, and the required air flow rate Qa.

In step S208, the control unit 151 opens the fuel gas discharge valve 114 and introduces discharged hydrogen into the discharged hydrogen combustor 115. In step S209, the control unit 151 determines if the hydrogen discharge is finished. If so, the control unit 151 proceeds to step S210. If not, the control unit 151 repeats step S209 and waits until the hydrogen discharge finishes.

In step S210, the control unit closes the fuel gas discharge valve 114 and stops the discharge of anode off gas to the outside of the system. In step S211, the control unit closes the air supply valve 127 and stops the supply of air to the discharged hydrogen combustor 115. Meanwhile, the control unit 151 returns the rotational speed of the compressor 122 and the opening degrees of the oxidant gas supply valves 124, 125 to values corresponding to the original operating conditions.

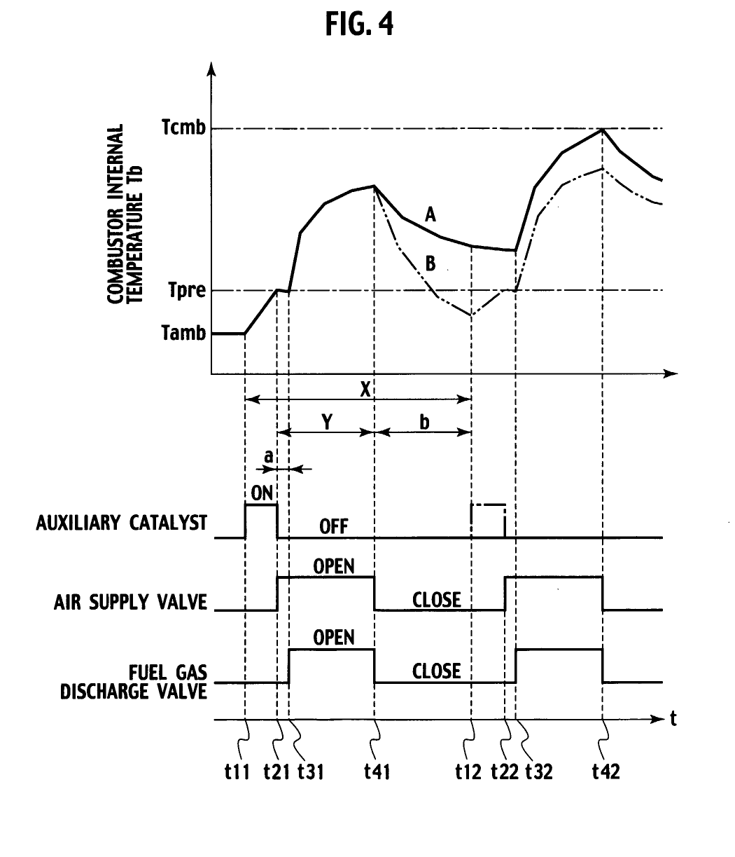

FIG. 4 shows the combustor internal temperature Tb and the operation of the auxiliary catalyst 1152, the air supply valve 127, and the fuel gas discharge valve 114. In this embodiment, the discharge of the anode off gas is assumed to be executed intermittently and periodically (cyclically); in FIG. 4, X is the period of the discharge cycle and Y is the duration (i.e., the portion of the discharge period X) during which the air supply valve 127 is open. When hydrogen discharge is executed, the combustor internal temperature Tb is the same as the ambient temperature Tamb and generally has not reached the ignitable temperature Tpre of the discharged hydrogen. Consequently, the inside of the discharged hydrogen combustor 115 is heated with the auxiliary catalyst 1152 before the fuel gas discharge valve 114 is opened (i.e., at time t11). When the combustor internal temperature Tb reaches the ignitable temperature Tpre (at time t21), the heating is stopped and the air supply valve 127 is opened. Then, the control unit 151 waits until the hydrogen discharge timing is reached (at time t31). At the hydrogen discharge timing, the fuel gas discharge valve 114 is opened and the discharged hydrogen is allowed to enter the discharged hydrogen combustor 115. Although the combustor internal temperature Tb temporarily declines during the period of time (duration a in the figure) from when the catalyst heating is stopped until the hydrogen discharge timing is reached, the combustor internal temperature Tb rises again when the combustion begins as a result of the introduction of the discharged hydrogen. When the open duration Y of the air supply valve 127 has elapsed, the air supply valve 127 and the fuel gas discharge valve 114 are both closed. Thereafter, the combustor internal temperature Tb declines again because the supply of reaction gases to the discharged hydrogen combustor 115 is interrupted until the next discharge cycle is reached. If the combustor internal temperature Tb is at or above the ignitable temperature Tpre when the next discharge cycle starts (at time t12) (the change in combustor internal temperature Tb for such a case is indicated with solid line A in the figure), the air supply valve 127 is opened at a prescribed open timing (time t22) and the fuel gas discharge valve 114 is opened at the hydrogen discharge timing (time t32) without heating the auxiliary catalyst 1152. Conversely, if the combustor internal temperature Tb is below the ignitable temperature Tpre when the next discharge cycle starts (at time t12) (the change in combustor internal temperature Tb for such a case is indicated with double-dot chain line B in the figure), the inside of the discharged hydrogen combustor 115 is heated in the same manner as described previously until the ignitable temperature Tpre is reached and the air supply valve 127 and the fuel gas discharge valve 114 are opened at the prescribed times t22 and t32, respectively. When the balance is maintained between energy taken in due to heating during the combustion of the discharged hydrogen and energy lost due to cooling during the period when the supply of reaction gases is stopped, the combustor internal temperature Tb will vary between the ignitable temperature Tpre and the combustion temperature Tcmb. Depending on such factors as the shape of the device and the operating conditions, it is also acceptable to reverse the order of the opening timing t21 (t22) of the air supply valve 127 and the opening timing t31 (t32) of the fuel gas discharge valve 114.

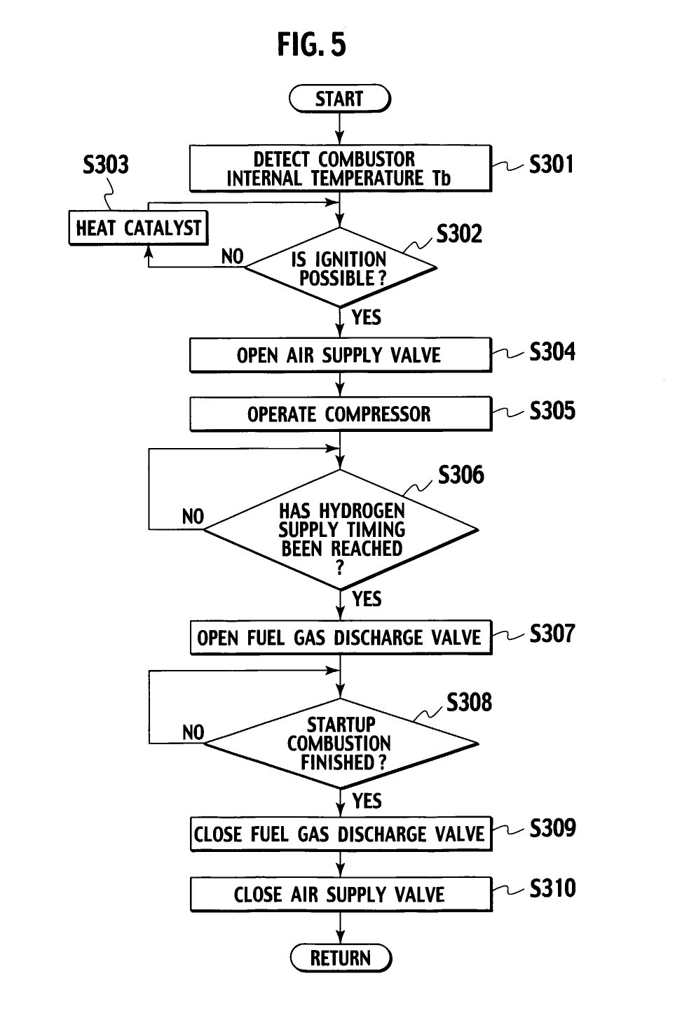

FIG. 5 shows a flowchart of a startup combustion control routine. When the electric power generating system 1A is started up, startup combustion control is executed before changing over to normal control. In step S302, the control unit 151 determines if the detected combustor internal temperature Tb has reached the ignitable temperature Tpre of the discharged hydrogen. If so the control unit 151 proceeds to step S304, if not the control unit 151 proceeds to step S303. The determination regarding ignitability is not limited to methods based on the combustor internal temperature Tb; the determination can also be made, for example, based on conditions related to the amount of moisture remaining inside the discharged hydrogen combustor 115 after the hydrogen discharge was stopped in the previous cycle. This residual moisture amount can be calculated based on the operating conditions of the fuel cell 101 when the hydrogen discharge was stopped in the previous cycle. In step S303, the control unit 151 heats the inside of the discharged hydrogen combustor 115 with the auxiliary catalyst 1152. After the combustor internal temperature Tb reaches the ignitable temperature Tpre, in step S304 the control unit 151 sets (calculates) the flow rate of hydrogen that can generate the amount of heat required for the startup combustion (hereinafter called “required hydrogen flow rate”) and the flow rate of air required to maintain the hydrogen combustion temperature at a prescribed temperature (hereinafter called the “required air flow rate”) and controls the opening degree of the air supply valve 127 in accordance with the calculated required air flow rate.

In step S305, the control unit 151 calculates the compressor rotational speed required to reach the required air flow rate and operates the compressor 122 at the calculated compressor rotational speed. In this embodiment, the oxidant gas supply valve 124 is closed fully so that all of the air exiting the compressor 122 is delivered to the discharged hydrogen combustor 115. In step S306, the control unit 151 determines if the open timing of the fuel gas discharge valve 114 (hereinafter also called “hydrogen supply timing”) has been reached. If the hydrogen supply timing has been reached, the control unit 151 proceeds to step S307. If not, the control unit 151 repeats step S306 and waits until the hydrogen supply timing is reached. Similarly to the aforementioned hydrogen discharge timing, the hydrogen supply timing is set in relation to the open timing of the air supply valve 127 and the operation timing of the compressor.

In step S307, the control unit 151 opens the fuel gas discharge valve 114 and supplies hydrogen to the discharged hydrogen combustor 115. Since the control unit 151 waits until the hydrogen supply timing is reached before opening the fuel gas discharge valve 114, the hydrogen and the air are delivered to the discharged hydrogen combustor 115 substantially simultaneously. In step S308, the control unit 151 determines if the startup combustion is finished. If so, the control unit 151 proceeds to step S309. If not, the control unit 151 repeats step S308.

In step S309, the control unit 151 closes the fuel gas discharge valve 114 and stops the supply of hydrogen to the discharged hydrogen combustor 115. In step S310, the control unit 151 closes the air supply valve 127 and stops the supply of air to the discharged hydrogen combustor 115. Meanwhile, the control unit 151 opens the oxidant gas supply valves 124, 125 and supplies air to the cathode of the fuel cell 101.

Although in this embodiment the oxidant gas supply valve 124 is closed fully during the startup combustion and the air supply valve 127 is closed fully when the startup combustion if finished, it is also acceptable to open the oxidant gas supply valves 124, 125 to the required opening degree when it is necessary to supply air to the cathode during startup combustion. Also, it is acceptable not to fully close the air supply valve 127 when it is necessary to continue combustion after startup combustion is finished.

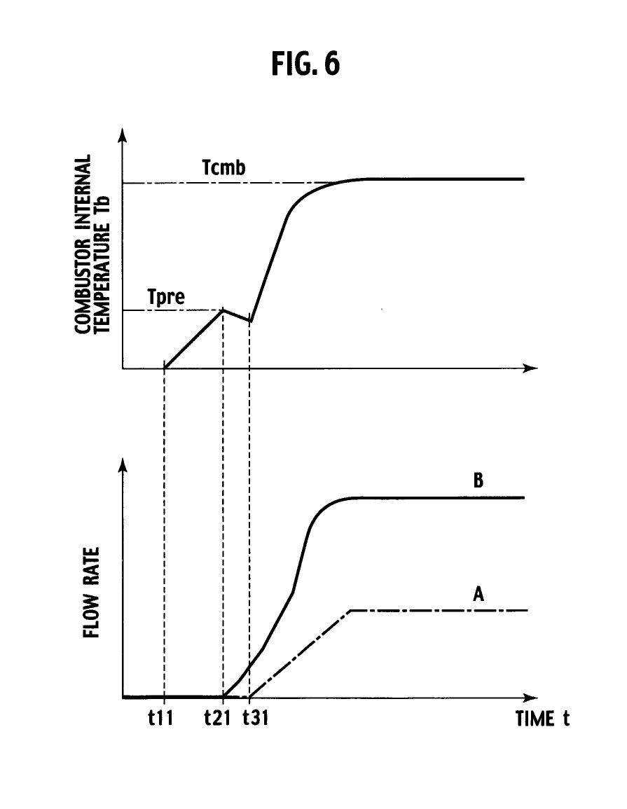

FIG. 6 shows the combustor internal temperature Tb and the flow rates of hydrogen and air (curve A indicates hydrogen and curve B indicates air) supplied to the discharged hydrogen combustor 115 during startup combustion control. If the combustor internal temperature Tb is below the ignitable temperature Tpre when the startup combustion control starts (at time t11), the control unit 151 heats the inside of the discharged hydrogen combustor 115 with the auxiliary catalyst 1152 before opening the air supply valve 127 and operating the compressor 122. When the ignitable temperature Tpre is reached (at time t21), the control unit 151 stops heating the auxiliary catalyst, opens the air supply valve 127, and operates the compressor 122. Then, the control unit 151 waits until the hydrogen supply timing is reached (at time t31) and opens the fuel gas supply valve 114 to supply hydrogen to the discharged hydrogen combustor 115. Although the combustor internal temperature Tb temporarily declines after the catalyst heating is stopped, the combustor internal temperature Tb rises and stabilizes at the combustion temperature Tcmb when the combustion begins as a result of supplying hydrogen. The effects that can be obtained with this embodiment will now be described.

Since the air supplied to the discharged hydrogen combustor 115 (“treatment unit”) through the air branch pipe 126 is drawn from the air supply pipe 121 at a position upstream of the cathode, the optimum quantity of air can be supplied to the discharged hydrogen combustor 115 regardless of the operating conditions of the fuel cell 101. Additionally, since the flow rate of the air supplied to the cathode is maintained both before and during the hydrogen discharge, the energy consumption can be prevented from increasing due to humidification and the balance between the intake and outlet of moisture can be prevented from degrading. Furthermore, since the air supplied to the discharged hydrogen combustor 115 has a higher oxygen concentration and a lower humidity than the cathode off gas, the ignitability of the discharged hydrogen in the discharged hydrogen combustor 115 can be improved and the treatment of the discharged hydrogen can be conducted in a stable manner.

Additionally, the hydrogen discharge control executed in this embodiment can be applied to situations in which the gas inside the anode is replaced with a filler gas when the fuel cell 101 is stopped (i.e., when stop control is executed). More specifically, when the gas inside the anode is discharged and replaced with a filler gas as part of the stop control, the hydrogen discharge control of this embodiment can be used to introduce the discharged hydrogen into the discharged hydrogen combustor 115 while simultaneously introducing the quantity of air required to combust the hydrogen into the discharged hydrogen combustor 115 and combusting the hydrogen. If the combustor internal temperature Tb is below the prescribed ignitable temperature Tpre, the inside of the discharged hydrogen combustor 115 can be heated with the auxiliary catalyst 1152 to ensure the ignitability before the hydrogen discharge is executed.

### Second Embodiment

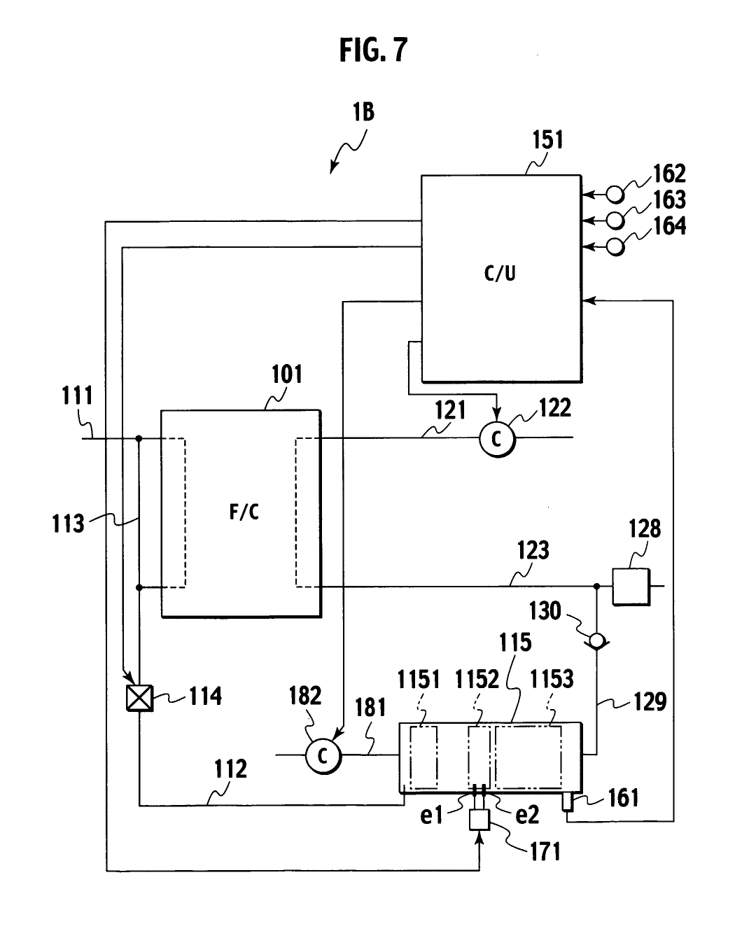

FIG. 7 shows the constituent features of a power generating system 1B in accordance with a second embodiment of the present invention. In addition to the compressor 122, the air branch pipe 126, and the air supply valve 127 mentioned in the first embodiment, an off gas treatment device in accordance with the second embodiment also includes the following constituent components: an air supply pipe 181 and a compressor (which corresponds to the “second air supply unit” and can be a blower, fan, or other comparatively low-pressure compressor) 182. The air supply pipe 181 corresponds to the supply passage and is provided independently of the air supply pipe 121 serving as the “cathode-side introducing passage”. One end of the air supply passage 181 is open to the atmosphere and the other end is connected to the discharge hydrogen combustor 115. The compressor 182 is connected to the air supply pipe 181 and supplies compressed air to the discharged hydrogen combustor 115. Otherwise, the constituent features are the same as in the first embodiment. More particularly, the following features are the same: a fuel gas discharge pipe 112 and a fuel gas supply pipe 111 are connected by a fuel gas recirculation pipe 113; the fuel discharge pipe 112 is connected to the discharged hydrogen combustor 115; the discharged hydrogen combustor 115 includes a dilution element 1151, an auxiliary catalyst 1152, and a main catalyst 1153 that are built in thereto; the auxiliary catalyst 1152 has a self heating function; an exhaust muffler 128 is installed in the air discharge pipe 123; a combustion gas discharge pipe 129 connects the discharge hydrogen combustor 115 to the air discharge pipe 123 at a position upstream of the exhaust muffler 128.

The power generating system 1B can accomplish hydrogen discharge control and startup combustion control by replacing the control of the compressor 122, air supply valve 127, and oxidant gas supply valves 124, 125 used in the first embodiment with a control of the compressor 182. The hydrogen discharge control and startup combustion control of the second embodiment will now be explained while indicating the corresponding steps of the flowcharts shown in FIGS. 3 and 5. In hydrogen discharge control, the discharged hydrogen flow rate Qh and the required air flow rate Qa are calculated based on the operating conditions of the fuel cell 101 (step S202) and the discharged hydrogen combustor 115 is preheated with the auxiliary catalyst 1152 if the combustor internal temperature Tb is below the ignitable temperature Tpre of the discharged hydrogen (steps S203 to S205). After the ignition conditions have been satisfied, the compressor 182 is operated at a rotational speed corresponding to the required air flow rate Qa (step S206), the hydrogen discharge timing is waited for (step S207), and the fuel gas discharge valve 114 is opened when the hydrogen discharge timing is reached to allow the discharged hydrogen to flow into the discharged hydrogen combustor 115 (step S208). When the hydrogen discharge is finished, the fuel gas discharge valve 114 is closed and the compressor 182 is stopped (steps S209 to S211).

Meanwhile, in the startup combustion control, the inside of the discharged hydrogen combustor 115 is preheated with the auxiliary 1152 as required (steps S301 to S303) and, after the ignition conditions are satisfied, the compressor 182 is operated (step S305). When the hydrogen supply timing is reached, the fuel gas discharge valve 114 is opened and the hydrogen is supplied to the discharged hydrogen combustor 115 (steps S306 and S307). After the startup combustion is finished, the fuel gas discharge valve 114 is closed and the compressor 182 is stopped (steps S308 to S310).

Also, similarly to the first embodiment, the hydrogen discharge control of the second embodiment can be applied to the stop control of the fuel cell 101.

With the second embodiment, a dedicated compressor 182 is provided for supplying air to the discharged hydrogen combustor 115 and, thus, a small compressor can be used for each of the compressors 122, 182. As a result, vibrations can be reduced and the components of the power generating system 1B can be arranged in an efficient fashion. Also, since the compressors 122, 182 can be operated independently of each other, the optimum quantity of air can be supplied to the discharged hydrogen combustor 115 without supplying an excessive amount of air to the cathode and thereby degrading the balance between the intake and outlet of moisture to and from the cathode.

### Third Embodiment

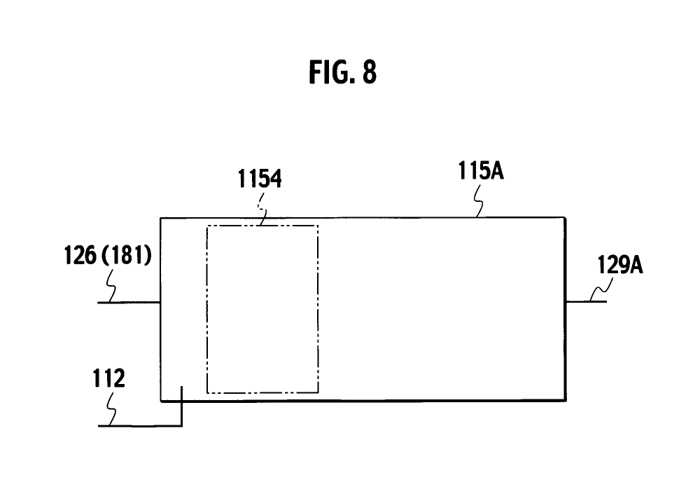

FIG. 8 shows the constituent features of an off gas treatment device in accordance with a third embodiment of the present invention. In this embodiment, a dilution mixer 115A serves as the “treatment unit”. The dilution mixer 115A has a built-in dilution element 1154 made up of porous plates or the like. An air branch pipe 126 and a fuel gas discharge pipe 112 are connected to the dilution mixer 115A. Similarly to the first embodiment, the dilution mixer 115A and an air discharge pipe (123) are connected together by a diluted gas discharge pipe 129A that serves as the “connecting passage”. The discharged hydrogen introduced into the dilution mixer 115A is diluted to a concentration of, for example, 2% or less by the air supplied through the air branch pipe 126 and discharged to the air discharge pipe (123) through the diluted gas discharge pipe 129A.

With this embodiment, the hydrogen discharge control and the startup combustion control can be executed in the same manner as the first embodiment (excluding the steps S203 to S205 (FIG. 3) and the steps S301 to S303 (FIG. 5) for ensuring ignitability). This embodiment is different, however, in that the required air flow rate Qa is set from the viewpoint of diluting the discharged hydrogen instead of combusting the discharged hydrogen. Consequently, the required air flow rate Qa is generally set to a larger flow rate than in a case where the discharged hydrogen is to be combusted. Another difference is that while in the first embodiment the timings at which the discharged hydrogen and the air are supplied to the discharged hydrogen combustor 115 are synchronized, in the third embodiment it is preferable for the hydrogen discharge timing or the hydrogen supply timing to be set such that the air is supplied to the dilution mixer 115A before the hydrogen.

It is also acceptable to connect an air supply pipe (181) serving as a “supply passage” to the dilution mixer 115A and provide a compressor (182) serving as a “second air supply unit” so that a compressor that is separate from the compressor (122) supplying air to the cathode is used to supply air to the dilution mixer 115A. An off gas treatment device employing the dilution mixer 115A can also be used to execute stop control of fuel cell 101.

With the third embodiment, the quantity of air required to dilute the discharged hydrogen can be supplied to the dilution mixture 115A regardless of the operating conditions of the fuel cell 101. As a result, the dilution of the discharged hydrogen can be conducted in a stable manner.

As explained previously, when a fuel cell power generating system in accordance with the present invention is used, the optimum quantity of air can be supplied to the anode off gas treatment unit regardless of the operating conditions of the fuel cell 101 because the air to be supplied to the treatment means is either drawn from a position upstream of where the air is supplied to the cathode of the fuel cell 101 or drawn from a separate source. Furthermore, since the air supplied to the treatment means has a higher oxygen concentration and a lower humidity than the cathode off gas, the ignitability of the anode off gas can be improved in cases where the anode off gas is treated by means of combustion.

The entire contents of Japanese patent application P2004-222830 filed Jul. 30, 2004 are hereby incorporated by reference.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description, and all changes which come within the meaning and range of equivalency of the claims are therefore intended to be embraced therein.

### INDUSTRIAL APPLICABILITY

The following are examples of applications in which the present invention can be applied: fuel cell automobiles, railroad vehicles capable of traveling through areas where electric power service is not available, and stationary fuel cell systems.

1. A fuel cell power generating system, comprising:
a fuel cell having an anode serving as a fuel electrode and a cathode serving as an oxidant electrode;
a treatment unit configured to treat anode off gas that is discharged from the anode of the fuel cell, by mixing or reacting the anode off gas with air;
a anode-side discharge passage configured and arranged to supply anode off gas to the treatment unit; and
a supply unit configured and arranged to supply air to the treatment unit, said air not being cathode off discharged from the cathode of the fuel cell.

2. The fuel cell power generating system as claimed in claim 1, wherein the supply unit comprises:
a first air supply unit configured and arranged to supply compressed air to the cathode through a cathode-side introducing passage arranged on the cathode side of the fuel cell; and
a branch passage configured and arranged to branch from the cathode-side introducing passage to connect to the treatment unit, and to supply said compressed air to the treatment unit.

3. The fuel cell power generating system as claimed in claim 2, further comprising:
a first flow rate control valve configured and arranged to control flow rate of air in the branch passage;
a discharge control valve configured and arranged to control flow rate of anode off gas in the anode-side discharge passage; and
a control unit configured to control the operation of the first flow rate control valve and the discharge control valve.

4. The fuel cell power generating system as claimed in claim 3, wherein
the control unit is configured to execute control in such a manner that the timing at which the anode-side discharge passage is opened from a fully closed state by the discharge control valve is different from the timing at which air is supplied to the treatment unit by the supply unit.

5. The fuel cell power generating system as claimed in claim 3, wherein
the control unit is configured to switch the timing at which the anode-side discharge passage is opened from a closed state by the discharge control valve between a first timing that is earlier than the timing at which air is supplied to the treatment unit by the supply unit and a second timing that is later than the timing at which air is supplied to the treatment unit by the supply unit.

6. The fuel cell power generating system as claimed in claim 1, wherein the supply unit comprises:
a supply passage provided independently from a cathode-side introducing passage on the cathode side of the fuel cell and connected to the treatment unit; and
a second air supply unit installed in the supply passage, said second air supply unit configured and arranged to supply air to the treatment unit through the supply passage.

7. The fuel cell power generating system as claimed in claim 1, further comprising:
a second flow rate control valve configured and arranged to control the flow rate of air supplied to the cathode of the fuel cell.

8. The fuel cell power generating system as claimed in claim 1, further comprising:
a connecting passage connecting the treatment unit to a cathode-side discharge passage that is a discharge passage on the cathode side of the fuel cell, said connecting passage configured and arranged to merge treated gas exiting the treatment unit with the cathode-side discharge passage.

9. The fuel cell power generating system as claimed in claim 8, further comprising:
an exhaust muffler provided in the cathode-side discharge passage and configured to exhaust the gas flowing through the cathode-side discharge passage.

10. The fuel cell power generating system as claimed in claim 9, wherein
the connecting passage is connected to the cathode-side discharge passage at a position upstream of the exhaust muffler.

11. The fuel cell power generating system as claimed in claim 8, further comprising:
a check valve installed in the connecting passage, said check valve configured to allow flow from the connecting passage to the cathode-side discharge passage.

12. The fuel cell power generating system as claimed in claim 1, wherein the treatment unit is a combustor configured to treat anode off gas by combusting the anode off gas.

13. The fuel cell power generating system as claimed in claim 1, wherein the treatment unit comprises:
a catalyst for combusting anode off gas; and
a heating unit configured to heat the catalyst to a temperature at which the anode off gas is ignited.

14. The fuel cell power generating system as claimed in claim 1, wherein the treatment unit is a dilution mixer configured to treat anode off gas by diluting the anode off gas.

15. The fuel cell power generating system as claimed in claim 1, further comprising:
a flow rate detecting unit configured and arranged to detect the flow rate of anode off gas in the anode-side discharge passage; and
a control unit configured to control the quantity of air supplied to the treatment unit by the supplying unit based on the flow rate of anode off gas detected by the flow rate detecting unit.

16. The fuel cell power generating system as claimed in claim 1, further comprising:
a recirculation passage connecting the anode-side discharge passage to an anode-side introducing passage arranged on the anode side of the fuel cell, said recirculation passage configured and arranged to recirculate anode off gas to the anode-side introducing passage; and
a discharge control valve configured and arranged to change a ratio of the flow rate of the anode off gas in the anode-side discharge passage to the flow rate of the anode off gas in the recirculation passage.

17. The fuel cell power generating system as claimed in claim 16, further comprising:
an operating condition detecting unit configured and arranged to detect operating conditions of the fuel cell; and
a control unit configured to control the discharge valve based on the operating conditions of the fuel cell detected by the operating condition detecting unit.

18. The fuel cell power generating system as claimed in claim 17, wherein
the control unit is configured to switch the timing at which the anode-side discharge passage is opened from a fully closed state by the discharge control valve between a first timing that is comparatively early in comparison with the timing at which air is supplied to the treatment unit by the supply unit and a second timing that is later than the first timing.

19. The fuel cell power generating system as claimed in claim 17, wherein
the second control unit is configured and arranged to open the anode-side discharge passage by means of the discharge control valve when the fuel cell is started up or stopped.

20. A fuel cell power generating system, comprising:
a fuel cell having an anode serving as a fuel electrode and a cathode serving as an oxidant electrode;
a treatment means for treating anode off gas that is discharged from the anode of the fuel cell, by mixing or reacting the anode off gas with air;
a anode-side discharge passage means for supplying anode off gas to the treatment means; and
a supply means for supplying air to the treatment unit, said air not being cathode off discharged from the cathode of the fuel cell.
